(19) United States
(12) Patent Application Publication
(10) Pub. No.: US 2026/0324567 A1
(43) Pub. Date: Oct. 22, 2026

(54) FERTIGATION CONTROL SYSTEM

(71) Applicant: ADDIUM, INC., Pullman, WA (US)

(72) Inventors: Scott H. CAMPBELL, Pullman, WA (US); Fred LIONETTI, Pullman, WA (US)

(21) Appl. No.: 19/648,903

(22) Filed: Apr. 15, 2026

Related U.S. Application Data
(60) Provisional application No. 63/792,564, filed on Apr. 22, 2025.

(51) Int. Cl. A01G 25/16

(52) U.S. Cl. CPC A01G 25/16

(57) ABSTRACT

A system for fertigation control can include a server computer including a processor and an electronic storage device, with the electronic storage device including electronic instructions to determine a pore water electrical conductivity of a growing medium in a fertigation unit, and a sensor communicatively coupled to the server computer and configured to collect data for determining the pore water electrical conductivity of the growing medium. The processor can execute electronic instructions including: assimilating the collected data from the sensor, applying the data into a distribution algorithm, calculating a value of the pore water electrical conductivity of the growing medium, comparing the value with a known tolerance value and a target value, and initiating at least one irrigation and drainage operation based on the value, the tolerance value, and the target value.

### CROSS-REFERENCE TO RELATED APPLICATIONS

This application claims the benefit of U.S. Provisional Patent Application No. 63/792,564, filed Apr. 22, 2025, entitled FERTIGATION CONTROL SYSTEM, the disclosure of which is incorporated by reference herein in its entirety.

### TECHNICAL FIELD

The present disclosure relates generally to control systems and more particularly to a remotely operated computerized system for monitoring, reporting on, and controlling irrigation and fertigation systems.

### BACKGROUND

A variety of systems for monitoring and controlling fertigation processes, irrigation systems, and other agricultural processes are utilized. Automatic systems can use remote sensors and controllers to monitor and automatically respond to system parameters to reach desired results. A number of control systems utilize computers to process system inputs, model system responses, and control actuators to implement process corrections within fertigation systems. Fertigation systems can be optimized and improved in controlling production processes by implementing computerized control systems.

Periodic monitoring systems (those that do not operate on a predetermined cycle) are inherently inefficient as they require a technician or other intervention to physically traverse an area to record data, repair out of order equipment, adjust settings, and the like. Such service trips are carried out with the associated costs being transferred to the consumers of the service.

Intelligent irrigation can include a controller to carry out program setting to fertigation time, fertigation amount, and the like. This can reduce labor intensity, improve watering and fertilizer efficiency, and realize improved crop yields, but current systems are too prone to errors, and systems may not be designed to monitor essential parameters that affect plant growth demand and moisture and nutrient application, which can cause difficulties to realize accurate and effective fertigation.

Accordingly, alternative solutions to applying monitoring and control system solutions to fertigation systems that overcome the shortcomings of the previous systems is desired.

### SUMMARY

Embodiments disclosed herein include systems, assemblies, and methods for controlling fertigation and/or irrigation systems. Specifically, a fertigation system can include a server computer including a processor and an electronic storage device, the electronic storage device including electronic instructions to determine a pore water electrical conductivity of a growing medium in a fertigation unit; and a sensor communicatively coupled to the server computer and configured to collect data for determining the pore water electrical conductivity of the growing medium. The processor may be configured to execute the electronic instructions, including: assimilating the collected data from the sensor, applying the collected data into a distribution algorithm, calculating a value of the pore water electrical conductivity of the growing medium, comparing the value with a known tolerance value and a target value, and initiating at least one irrigation and drainage operation based on the value, the tolerance value, and the target value.

In an example, the collected data from the sensor can include at least a bulk permittivity, electrical conductivity, a volumetric water content, and a temperature of the growing medium. In some examples, the fertigation control system can further include a water control assembly in communication with the processor, the water control assembly including at least one water supply valve and at least one actuator. The electronic instructions can comprise instructing the processor to transmit a first control signal to activate the water control assembly to initiate irrigation and drainage operations. In an example, the electronic instructions can further comprise instructing the processor to transmit a second control signal to deactivate the water control assembly to terminate irrigation and drainage operations. In some examples, the irrigation and drainage operations comprise modifying a volume or a duration of the at least one irrigation and drainage operation based on the pore water electrical conductivity of the growing medium. In some examples, the sensor can include a dielectric sensor.

In some examples, an irrigation system can include a plant system and a watering system configured to water the plant system. The irrigation system can also include a plurality of electrical conductivity (EC) sensors configured to measure EC values in the growing medium of at least one plant area of the plant system. The system can also include a controller configured to receive data from the plurality of EC sensors. In an example, the controller is configured to calculate a representative pore water electrical conductivity value from the plurality of EC sensors, calculate a measure of variability of the pore water electrical conductivity from the plurality of EC sensors, compare the representative pore water electrical conductivity value and the measure of variability with a known tolerance value and a target value, and perform irrigation and drainage operations according to the representative pore water electrical conductivity value, the measure of variability, the known tolerance value, and the target value.

In an example, the plurality of EC sensors can include dielectric sensors. In an example, the plurality of EC sensors are configured to collect at least a bulk permittivity, electrical conductivity, a volumetric water content, and a temperature of the growing medium. In at least one example, the irrigation system further includes a water control assembly in communication with the controller, the water control assembly including at least one water supply valve and at least one actuator. In some examples, the controller is configured to instruct the watering system to transmit control signals to activate the water control assembly to initiate and terminate irrigation and drainage operations. In some examples, the controller includes a processor configured to perform an algorithm to assimilate the collected data received from the plurality of sensors and apply the data to calculate the representative pore water electrical conductivity value. In an example, the irrigation system includes a database including historical data of growing medium conditions and watering events.

In some examples, a method of controlling watering of a plant system can include positioning a monitoring device in a growing medium. The method can further include collecting data to determine a pore water electrical conductivity of the growing medium, assimilating the collected data to a database of a computing device communicating with the monitoring device, applying the collected data into a watering system algorithm, and calculating one or more growing medium indicators to control a watering system to perform irrigation and drainage operations according to the pore water electrical conductivity of the growing medium.

In an example, the method can further include collecting historic data corresponding to the growing medium conditions and watering frequency and linking the historic data to the database of the computing device. In an example, the method can also include sensing the data about the conditions of the growing medium through the monitoring device, logging the sensed data of the conditions of the growing medium, and storing the sensed data to the database of the computing device.

In an example, the method can further include actuating a water control assembly in communication with the computing device, the water control assembly including at least one water supply valve and at least one actuator. In an example, the computing device is configured to activate and deactivate the water control assembly to perform irrigation and drainage operations. In at least one example, the monitoring device can include a sensor configured to collect at least a bulk permittivity, electrical conductivity, and a temperature of the growing medium.

The above summary of the present invention is not intended to describe each embodiment or every implementation of the present invention. Features from any of the disclosed embodiments may be used in combination with one another, without limitation. In addition, other features and advantages of the present disclosure will become apparent to those of ordinary skill in the art through consideration of the following detailed description and the accompanying drawings. The Figures and the detailed description that follow more particularly exemplify one or more preferred embodiments.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of an irrigation system.

FIG. 2 is a block diagram of a fertigation control system.

FIG. 3 is a block flow diagram for a method to control watering of a plant system.

FIG. 4 is a graphical representation of applying collected data from a sensor into a watering system algorithm to perform irrigation and drainage operations according to the pore water electrical conductivity of the growing medium.

FIG. 5 is another graphical representation of applying collected data from a sensor into a watering system algorithm to perform irrigation and drainage operations according to the pore water electrical conductivity of the growing medium.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

Embodiments disclosed herein are related to assemblies, systems, and methods of controlling an irrigation or fertigation system. The assemblies, systems, and methods of controlling an irrigation or fertigation include a system for monitoring growing medium properties and conditions to assist those who manage and maintain the crops using accurate and current data to assist them in the watering and fertilization of the growing medium based on the specific plant or crops needs. In some examples, the control system can be attached to a sensor configured to, at least in part, provide a measurement of the electrical conductivity (EC) and/or pore water electrical conductivity (EC_{pw}) of the growing medium in the system. As used herein, a “growing medium” can refer to any substrate that can support a plant. For example, the growing medium can include a soil, soil replacement mixture, organic material, compost, potting mix, perlite, vermiculite, worm castings, clay, charcoal, coconut coir, peat, rock wool, sand, gravel, other aggregate mediums, any other suitable alternative porous materials, or combinations thereof. The fertigation system can indicate the growing conditions for a plant system and provide a user an effective watering system and that is easy to install, collects accurate data, and automatically keeps the plant system properly fertigated.

Specific embodiments of the disclosure are described with reference to the accompanying drawings. This disclosure may, however, be embodied in many different forms and should not be construed as limited to the embodiments set forth herein; rather, these embodiments are provided so that this disclosure will be thorough and complete, and conveys the scope of the disclosure to those skilled in the art. The terminology used in the detailed description of the embodiments illustrated in the accompanying drawings is not intended to be limiting of the disclosure.

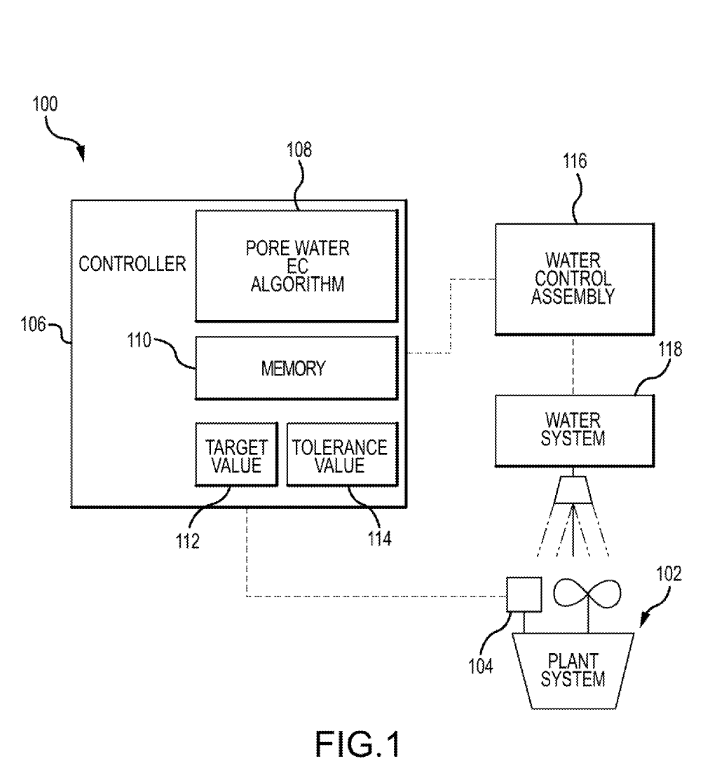

FIG. 1 is a block diagram of an irrigation system 100. The irrigation system 100 is configured to support a plant system 102. In some examples, the plant system can include whole plant crops covering fields or acres of land, singular plants, seeds (including embryo, endosperm, and seed coat), fruits, fertigation systems, greenhoused plants, substrate-based agricultural systems, and the like. Integrated with the plant system 102 can be a sensor 104 configured to measure conditions at the plant system 102. In some examples, the sensor can include an EC sensor. The EC sensor can be configured to measure a value in the growing medium of at least one plant area. The sensor 104 can include several features. In some examples, the sensor 104 can be configured to collect one or more of a bulk permittivity, electrical conductivity, a volumetric water content, and a temperature of the growing medium.

In some examples, the sensor 104 can include a dielectric sensor. The sensor 104 can include an electrical conductivity and permittivity sensor having at least one prong positioned to periodically measure growing medium and/or plant conditions. For example, the sensor 104 may include a sensor disclosed in U.S. Patent Application No. 18/656,390, filed on May 6, 2024, or in U.S. Patent No. 11,415,612, issued Aug. 16, 2022, the disclosures of which are incorporated by reference herein, in their entireties.

In some examples, the sensor 104 can be operationally coupled to a controller 106. Generally, the controller 106 can include a system that receives an input signal from the sensor 104, compares this value with that of a predetermined control point value (e.g., a set point), and determines the appropriate amount of output signal required by a final control element (e.g., a watering system) to provide corrective action for the plant system, acting as a control loop. For example, in some examples, the sensor 104 installed at the plant system 102 can send an input signal to the controller 106. The input signal can indicate a growing medium or plant condition measured at the plant system 102. In some examples, the sensor 104 can send signals to the controller 106 at a predetermined set interval. In other examples, the sensor can send signals continuously (e.g., in real-time) or intermittently (e.g., when certain plant conditions are detected or based on external factors such as user interaction with the sensor 104, environmental conditions of the plant system 102, or other related factors). The controller 106 can receive and analyze the signal from the sensor 104 and produce and send an output signal to the control element (e.g., a water control assembly 116). In some examples, the controller 106 includes a computer and other electronic components, as described in below. The controller 106 can thereby be configured to measure and record at least one of a bulk permittivity, an electrical conductivity, a volumetric water content of the plant or plant system 102, and/or temperature of the growing medium and to provide status feedback of the components in the irrigation system 100.

The controller 106 can use the inputs from the sensor 104 to conduct an algorithm or set of electronic instructions and to calculate the pore water EC for the growing medium in the plant system 102. As noted, the sensor 104 can be configured to measure the EC of the growing medium in the plant system 102.

As used herein, the bulk conductivity of a growing medium refers to the conductivity of everything in the volume being measured, including the water, nutrient ions, the growing medium particles and any organics (including the roots) in the growing medium. The bulk conductivity is affected by the moisture content of the growing medium. As used herein, the pore water EC is the conductivity of the water in and around the growing medium pores. Bulk growing medium electrical conductivity gives a general idea of the growing medium's overall salinity level, but it does not provide accurate information on the concentration and availability of dissolved nutrients in the growing medium. In contrast, pore water EC gives a more precise estimation of the solubility of nutrients in the growing medium which directly affect plant growth and health. Thus, the “pore water” refers to water that fills the voids or spaces between growing medium particles and is not bound to the growing medium. This pore water can conduct electricity and has a different electrical conductivity than the bulk conductivity of the bulk growing medium. The pore water EC is therefore effectively the conductivity of the water that is available to the plant to consume. Pore water EC can be affected by temperature and may require a minimum water content to measure with accuracy.

Pore water electrical conductivity reflects the growing medium's salinity and the availability of nutrients to plants. To calculate the pore water electrical conductivity, the controller 106 can receive a bulk growing medium electrical conductivity and growing medium permittivity from the sensor 104. The permittivity is a measure of the ability of the growing medium to store electrical energy.

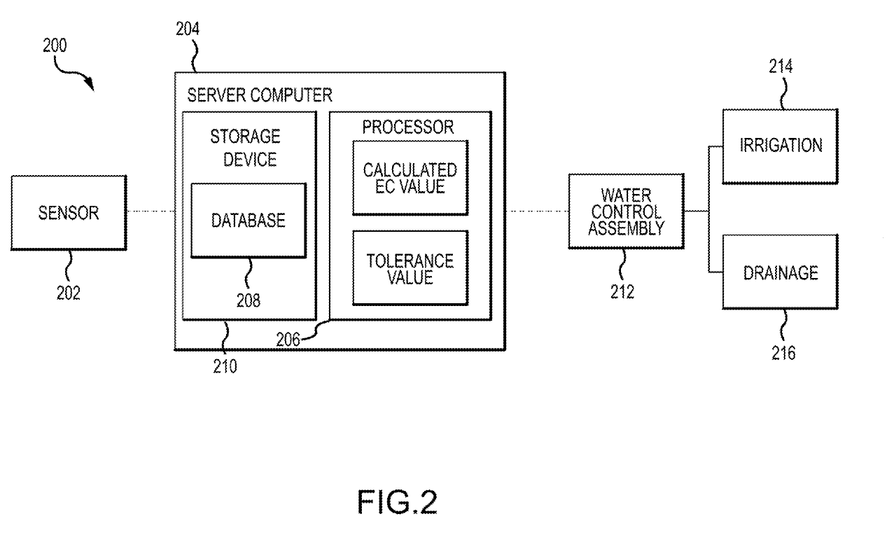

In some examples, the controller 106 can include a processor configured to execute an algorithm or a set of electronic instructions to assimilate the collected data received from the sensor and to apply the data to calculate the pore water electrical conductivity value of the plant system 102. In some examples, the controller 106 includes a memory 110 (e.g., an electronic memory device). The memory 110 can be configured to store historical data. The memory 110 can include a database including historical data of growing medium conditions and watering events. In other words, the controller 106 can include at least one memory storage medium (e.g., a memory 110 and/or storage device). The controller 106 may include a memory 110, which can be operably coupled to a processor within the controller 106. The memory 110 may be used for storing historical data, metadata, and programs for execution by the controller 106. The memory 110 may include one or more of volatile and non-volatile memories, such as Random Access Memory (RAM), Read-only Memory (ROM), a solid-state disk (SSD), Flash, Phase Change Memory (PCM), or other types of data storage. The memory 110 may be internal or distributed memory. The controller 106 can include components discussed in connection with computer 204 of FIG. 2.

The controller 106 may include the memory 110 having storage for storing data or instructions. The memory 110 may be operably coupled to at least one processor that is configured to set tolerance bands and target values as well as calculate the pore water EC. In some examples, the memory 110 may comprise a non-transitory memory storage medium, such as any of those described above. The memory 110 (e.g., non-transitory storage medium) may include a hard disk drive (HDD), a floppy disk drive, flash memory, an optical disc, a magneto-optical disc, magnetic tape, or a Universal Serial Bus (USB) drive or a combination of two or more of these. Memory 110 may include removable or non-removable (or fixed) media. Memory 110 may be internal or external to the controller 106. In some examples, memory 110 may include non-volatile, solid-state memory. In some examples, memory 110 may include read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these. In some examples, one or more portions of the memory 110 (e.g., memory storage medium(s)) may store one or more databases thereon (e.g., database 208 of FIG. 2).

In some examples, one or more of a history of the volume of water delivered to the plant system 102, a trend of the volume of water or environment conditions at the plant system 102, a history of irrigation and drainage, and/or a history of system failures or abnormal events may be stored in a memory storage medium such as the memory 110 of the controller 106.

The controller 106 can include any components and systems to enable the irrigation system 100 to receive data from the sensor 104, calculate a pore water electrical conductivity value, and compare the calculated pore water electrical conductivity value with one or more of a known or pre-set target value 112 and a tolerance value 114 to perform irrigation and drainage operations according to the pore water electrical conductivity of the growing medium. In some examples, the target value 112 and the tolerance value 114 can be predetermined and fixed values based on the environment, growing medium conditions, and plant system 102 parameters. In other examples, the target value 112 and the tolerance value 114 can be dynamic values, either automatically adjusted by the controller 106 or by a user. Example target values 112 and tolerance values 114 can be values of average pore water EC for a set of plants, values of the standard deviation of the pore water EC (or other measures of variability) for the plants, similar values, or combinations thereof, as further described below.

The controller 106 can be operationally coupled to a water control assembly 116. The water control assembly 116 can include at least one water supply valve and at least one actuator that is connected to a water system 118 configured to conduct watering events for the plant system 102. In some examples, the water control assembly 116 receives instruction from the controller 106 to initiate and terminate irrigation and drainage operations from a water source. In other words, the water control assembly 116 is configured to direct the watering system 118 to irrigate and/or drain the plant system 102 according to the instructions received from the controller 106.

FIG. 1 is a non-limiting example demonstrating some of the components of an irrigation system 100 that is configured to determine a pore water EC of a plant system 102 and utilize the calculated pore water EC to control the irrigation and drainage of the plant system 102. FIG. 1 is not intended to demonstrate or include all components of the systems and all embodiments of methods and systems configured to perform the disclosed operation.

Referring now to FIG. 2, a fertigation control system 200 can include a sensor 202 communicatively coupled to a server computer 204, and the sensor 202 can be configured to collect data for determining the pore water electrical conductivity of growing medium. The growing medium can include a crop or plant system (e.g., plant system 102). The sensor 202 can include any type of sensor discussed herein. In an example, the sensor 202 includes a dielectric sensor.

The server computer 204 may be a computing device configured to perform one or more of the acts and functions described above. The server computer 204 may include at least one processor 206, a database 208, a storage device 210, an input/output (“I/O”) device/interface to communicate with the sensor and a water control assembly 212, and a communication interface. While an example computing device is shown in FIG. 2, the components illustrated in FIG. 2 are not intended to be limiting of the server computer 204. Additional or alternative components may be used in some examples. Further, in some examples, the server computer 204 may include fewer components than those shown in FIG. 2.

In some examples, the processor 206 may include hardware for executing instructions (e.g., instructions for carrying out one or more portions of any of the methods disclosed herein), such as those making up a computer program. For example, to execute instructions, the processor 206 may retrieve the instructions from an internal register, an internal cache, the database 208, or other storage device and then decode and execute the instructions. In some examples, the processor 206 may be configured to carry out one or more portions of any of the example methods disclosed herein (e.g., it may include programming stored thereon or executed thereby to implement the methods).

The processor 206 can be executable using the server computer 204 and can be configured to perform an algorithm to assimilate the collected data received from the sensor 202, to apply the data into a distribution algorithm, and to calculate a pore water electrical conductivity value. In an example, the algorithm is configured to instruct the processor 206 to transmit a first control signal to activate the water control assembly 212 to initiate irrigation and drainage operations. In another example, the algorithm is configured to instruct the processor to transmit a second control signal to deactivate the water control assembly 212 to terminate irrigation and drainage operations.

In some examples, the processor 206 may be configured to perform any of the acts disclosed herein or cause one or more portions of the server computer 204 or a controller (e.g., controller 106) to perform at least one of the acts disclosed herein. Such configuration can include one or more operational programs (e.g., computer program products) that are executable by the at least one processor 206. For example, the processor 206 may be configured to automatically perform an algorithm to assimilate the collected data received from the sensor 202 and apply the data into a distribution algorithm and calculate the pore water electrical conductivity value (or an average (or other measure of central tendency) of the pore water EC, pore water EC standard deviation (or another measure of variability or dispersion of the data), or other representative or statistical value for multiple sensors), compare the calculated value with a known tolerance water value compared to a target value to perform irrigation and drainage operations according to the pore water electrical conductivity of the growing medium, automatically transmit a first control signal to activate the water control assembly to initiate irrigation and drainage operations, and/or automatically transmit a second control signal to deactivate the water control assembly to terminate irrigation and drainage operations.

The server computer 204 may include at least one database or memory storage medium (e.g., memory 110). The server computer 204 can include database 208, which is operably coupled to the processor 206. The database 208 can be used for storing data, metadata, and programs for execution by the processor 206. The database 208 may include one or more of volatile and non-volatile memory devices, such as those described above. The memory can be internal or distributed memory.

The server computer 204 can include a storage device 210 having storage for storing data or instructions including a calculated pore water electrical conductivity value. The storage device 210 may be operably coupled to the at least one processor 206. In some examples, the storage device 210 may comprise a non-transitory memory storage medium, such as any of those described above. In some examples, one or more portions of the storage device 210 (e.g., memory storage medium(s)) may store one or more of the databases 208 thereon.

In some examples, one or more of a history of the fertigation control system 200, a trend of the watering events including irrigation 214 and drainage 216, a history of the sensor 202, and/or a history of other components can be stored in a memory storage medium such as one or more of the processor 206 (e.g., internal cache of the processor), database 208, or the storage device 210.

The server computer 204 also includes one or more I/O devices/interfaces, which are provided to allow a user to provide input to, receive output from, and otherwise transfer data to and from the server computer 204. In some examples, the I/O devices/interfaces can include one or more devices for presenting output to a user, including, but not limited to, a graphics engine, a display (e.g., a display screen or monitor), one or more output drivers (e.g., display drivers), one or more audio speakers, and one or more audio drivers. In certain examples, I/O devices/interfaces are configured to provide graphical data to a display for presentation to a user. The graphical data may be representative of one or more graphical user interfaces and/or any other graphical content as may serve a particular implementation.

The server computer 204 may further include a communication interface. The communication interface can include hardware, software, or both. The communication interface can provide one or more interfaces for electronic communication (such as, for example, packet-based communication) between the server computer 204 and one or more networks. For example, a communication interface may include a network interface controller (NIC) or network adapter for communicating with an Ethernet or other wire-based network or a wireless NIC (WNIC) or wireless adapter for communicating with a wireless network, such as a WI-FI.

The fertigation control system 200 also includes a water control assembly 212 communicatively coupled to the server computer 204. Similar to the water control assembly 116 discussed above, the water control assembly 212 can include at least one water supply valve and at least one actuator that is connected to a watering system configured to conduct watering events for a plant system. In some examples, the water control assembly 212 receives instruction from the controller 106 (or 204) to initiate and terminate irrigation 214 and drainage 216 operations according to the instructions received from the server computer 204. In some examples, the irrigation and drainage operations include modifying fertigation parameters based on the pore water electrical conductivity of the growing medium. For example, modifying fertigation parameters can include modifying a volume or a duration of the irrigation and drainage operation. In other words, modifying fertigation parameters can include using the data collected from the sensors and the server computer 204 to determine how much water or how many nutrients should be administered to the plant system and then administering these changes.

In some examples, the fertigation control system 200 can be configured to operate the water control assembly 212 within predetermined and defined parameters. For example, a user can specify boundaries for the fertigation control system 200 and establish guardrails or operating limits for the behavior of the fertigation control system 200. In some examples, the guardrails can include upper and lower limits for the fertigation control system 200. For example, parameter limits can include a minimum and maximum nutrient application amount, a minimum and maximum duration of time between applications, a maximum and minimum bulk electrical conductivity of the growing medium, a maximum and minimum pore water electrical conductivity of the growing medium, an electrical conductivity correction goal for the plant system, a drainage goal for the plant system, initiation and termination irrigation 214 and drainage 216 operation limits, or any other suitable and applicable parameter.

In some examples, when the fertigation control system 200 and the water control assembly 212 is operating the predetermined established limits, the fertigation control system algorithm can be configured to automatically control watering events and fertigate the plant system. In the event when the environment conditions (or any abnormal event) cause the fertigation control system 200 to exceed the predetermined established limits, the fertigation control system 200 can include and implement an alert or alarm for the user and can thereby initiate or recommend manual operations so that the user can remedy the situation and control the watering events and fertigation of the plant system. In some examples, the fertigation control system 200 can record and display the history of the operations, including the abnormal event, the fertigation control system 200 can display to the user which events happened to cause the fertigation control system 200 to operate outside the established boundaries or guardrails and which events happened according to the fertigation control system algorithm.

In some examples, a user can select either Evapotranspiration (ET) or Vapor Pressure Deficit (VPD) high and low triggers values as control inputs to the fertigation control system. Evapotranspiration is the sum of all processes by which water moves from the substrate to the atmosphere via evaporation and/or transpiration. Vapor pressure deficit (VPD) is a measure of how dry or humid the air is. VPD can be calculated by comparing the amount of moisture in the air to how much moisture the air can hold when it's saturated. VPD is similar to relative humidity, which uses a percentage to describe how much moisture is in the air. In some examples, the algorithm can be configured to automatically calculate appropriate operating limits or guardrails according to the parameter limits. In some examples, the fertigation control system 200 could predict or use a predicted ET/VPD value provided to the fertigation control system 200 to calculate the guardrails based on current weather predictions.

A wireless or wired network connection can link the server computer 204 to the water control assembly 212 and sensor 202 for remote operation of the water control assembly 212. For example, the server computer 204 can be located at a different site (e.g., a server center) than the site of the water control assembly 212 and plants being monitored by sensor 202. In this manner, the plant systems being served by the water control assembly 212 can be automatically and remotely served without the control system, database 208, and electronic instructions being stored or executed at the same facility (e.g., farm or greenhouse) as the plant systems, water source, and other parts of the sensor 202 and water control assembly 212.

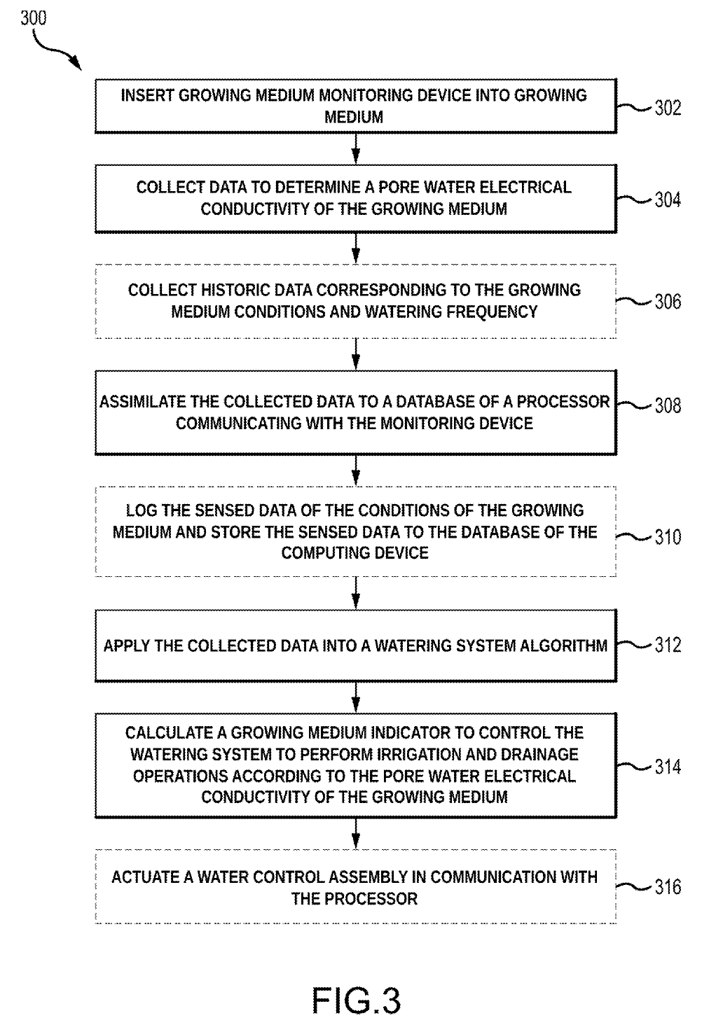

FIG. 3 is a block flow diagram of a method 300 to control watering of a plant system. The method 300 for controlling watering of a plant system can utilize use any of the sensor systems and/or fertigation and irrigation control systems or assemblies disclosed herein. The method 300 may be implemented using the various controllers and computers described herein. The method 300 may include inserting a monitoring device into a growing medium, as indicated in block 302. The monitoring device can include a sensor such as a dielectric sensor. In some examples, the sensor can be placed near a plant or in a plant system and can be configured to collect at least a bulk permittivity, electrical conductivity, and a temperature of the growing medium there.

The method 300 may further include collecting data from the monitoring device to determine a pore water electrical conductivity of the growing medium, as indicated in block 304. In some examples, the sensor is configured to collect all data required to conduct a calculation or perform an algorithm to determine a pore water electrical conductivity of the growing medium. Thus, by completing blocks 302 and 304, a sensor system, such as sensor 104, can be organized, assembled, and polled for data.

Blocks 302 and 304 of the method 300 are shown for illustrative purposes. For example, all acts or blocks illustrated of the method 300 may be performed in different orders, split into multiple acts, modified, supplemented, or combined. In an example, one or more of the acts of the method 300 may be omitted from the method 300. Any of the acts of the method 300 can include using any of the sensor assemblies or systems disclosed herein.

The method 300 can also optionally include collecting historic data corresponding to the growing medium conditions and watering frequency and linking the historic data to a database of the computing device, as indicated by block 306. The historic data can be stored in a database or other storage system located within a server computer or processor that is either local to the sensor or connected to the sensor via a network. In some examples, the historic data can be used as an input to the algorithm to determine the pore water electrical conductivity of the growing medium.

The method 300 may also include assimilating the collected data to a database of a processor communicating with the monitoring device, as shown in block 308. In some examples, the method also includes logging the sensed data of the conditions of the growing medium and storing the sensed data to the database of the computing device, as shown in block 310. As such, the data can be used for present and future calculations and for determining trends and establishing operating limits.

The method 300 may further include applying the collected data into a watering system algorithm, as shown in block 312. As noted above, the watering system algorithm may include at least a calculation method for determining the pore water electrical conductivity of the growing medium, which can then be used to perform irrigation and drainage operations and to modify fertigation parameters. For example, modifying fertigation parameters can include modifying a volume or a duration of the irrigation and drainage operation. In other words, using the data collected to determine how much water or how many nutrients should be administered to the plant system. Block 312 can be followed by block 314, including calculating one or more growing medium indicators to control the watering system to perform irrigation and drainage operations according to the pore water electrical conductivity of the growing medium. Block 314 can utilize use any of the water control systems or assemblies disclosed herein.

The method 300 may also include actuating the water control assembly in communication with the processor, as indicated by block 316. The water control assembly may include at least one water supply valve and at least one actuator configured to perform irrigation and drainage operations of the plant system from a water source (e.g., a water reservoir, water tank, or connection to a water utility).

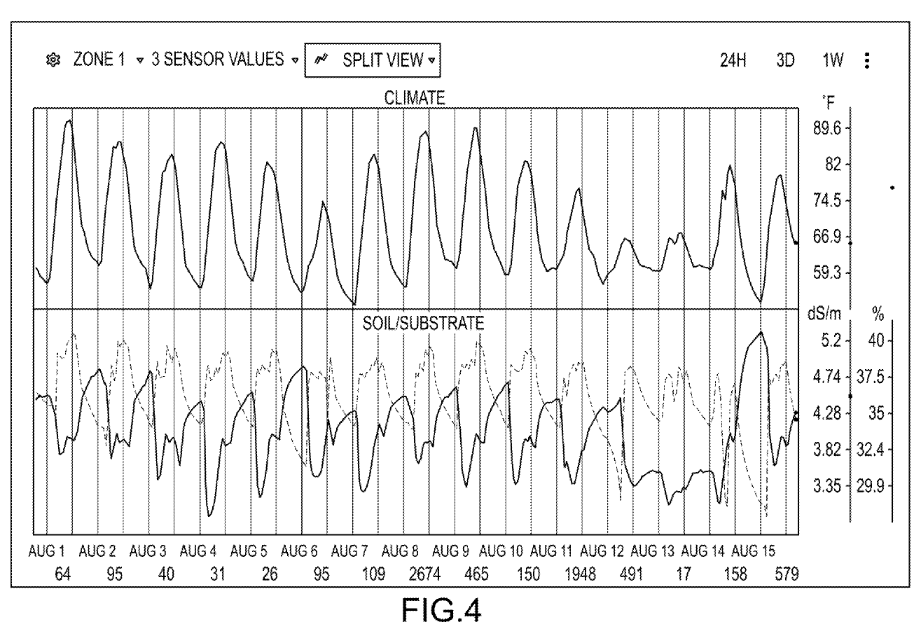

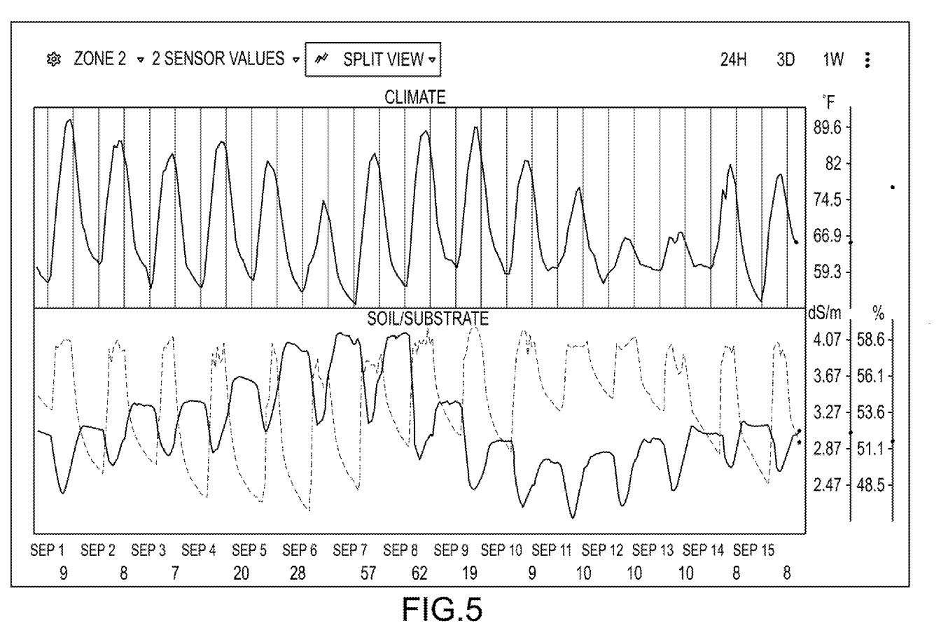

FIGS. 4-5 demonstrate examples of controlling watering of a plant system according to embodiments described herein. In accordance with one aspect of the invention, a system may be configured to monitor and report system parameters. In some examples, controlling watering of a plant system can include operating the water control assembly within predetermined and defined parameters. For example, a user can specify boundaries for the system and establish guardrails or operating limits for the behavior of the plant system and fertigation control system. In some examples, the guardrails can include upper and lower limits for the fertigation control system. The system can be implemented by using a wireless transceiver. At least one wireless transceiver is interfaced with a sensor, a server computer, water control system, or some other device associated with the application parameter of interest. In this regard, the term “parameter” is broadly construed and may include, but is not limited to, an environmental or weather condition, a system process variable, a growing medium condition as measured by the sensor, etc.

FIG. 4 is a graphic of a computer program interface showing data and user control elements of an example fertigation system at a “steady state” condition. The graph provides various climate parameters that can affect the growth of the plant or plant system. Further, the graph shows a calculated pore water EC value over time (lower dashed-line curve in the SOIL/SUBSTRATE section with the units dS/m) superimposed on a moisture content of the growing medium (lower solid-line curve in the SOIL/SUBSTRATE section with units of percent moisture). The graph is set to monitor the conditions constantly and throughout days, weeks, and/or months of time. In some examples, the growing medium indicators or parameters, such as pore water EC, can be a calculated value as determined by algorithm or can be directly measured by a sensor. According to the parameters and conditions, the processor is configured to activate and deactivate the water control assembly to perform irrigation and drainage operations, and the results of such operations can be observed (e.g., via the moisture content measurements). The upper solid-line curve (i.e., in the CLIMATE section) indicates temperature measured at the plant system over the 15-day span of time. Notably, the temperature fluctuates over time, predominantly rising during the day and falling overnight each day. On days with high temperatures, the moisture content (lower solid-line curve) may deplete quickly due to evaporation and plant transpiration effects, so the water control assembly can be operated to counteract anticipated drops in moisture content, as visible in the daily fluctuations of the pore water EC most prominently visible during the afternoon and evening daytime hours.

FIG. 5 is a graphic similar to FIG. 4 that shows an example fertigation system at a “dynamic” condition. In other words, the fertigation system is shown responding to a sensed abnormality in the plant system or growing medium to restore the system to normal conditions and keep the pore water EC consistent and within threshold ranges. As shown in FIG. 5, despite relatively consistent climate conditions, an event occurs on about September 9^{th} that causes the pore water EC to raise and the moisture content of the growing medium to decrease. Thus, the pore water EC and the moisture content diverge from typical ranges due to the climate event of September 9^{th}.

In response, the irrigation system or controller is configured to compare the calculated value of pore water EC with a known tolerance value compared to a target value to perform irrigation and drainage operations according to the pore water electrical conductivity of the growing medium and restore the system to normal operating conditions. In some examples, the response can be to initiate an alarm (e.g., a visual or audible alarm at the plant system’s location) and to indicate to an operator at the location to adjust the plant’s conditions manually (e.g., by increasing irrigation). In other examples, the system can respond to divergent conditions by remotely and automatically activating and deactivating the water control assembly to correct the condition by bringing the pore water EC and moisture content back within preferred target ranges. Since the parameters are sensed frequently (or constantly) and the sensor has high accuracy, corrective action can be observed over time. For the example shown in FIG. 5, normal conditions are shown to be restored by September 14^{th}.

In some examples, the fertigation control system can be configured to calculate a measure of central tendency of the pore water electrical conductivity values of the sensor data. For example, a representative value can be determined by finding an average pore water electrical conductivity value from a plurality of sensors deployed within a zone. In some cases, a weighted average (mean) can be used, with the weighting being based on the types of plants used with each sensor or other known differing conditions among the various sensors. The average pore water EC value can be one of the growing medium indicators of block 314 above. A zone can include an irrigation zone in which a user selects the zone and configures various settings or guardrails for control of the fertigation in that zone, such as a target value 112 and/or tolerance value 114 corresponding to the measured average EC. The system can measure EC values and take the average of however many sensors are deployed in the zone, with a minimum of two sensors and up to four or more sensors. A greater number of deployed sensors can give more accuracy to the overview of conditions occurring in the zone. The system can have a maximum EC threshold (e.g., a tolerance value 114), and once the threshold is crossed by the average value, the system can automatically send a flush shot to wash out plants in the zone for an amount of time that the user specifies and thereby reduce the EC.

In some examples, when making an irrigation decision based on the average of the pore water EC in a zone where each plant is in its own individual pot, no plant in the zone may be exactly the same as the average in the zone. For example, one plant could have a pore water EC of seven while another plant could have a pore water EC of three, with the deployed sensors being used to average out the values to make a decision based on the average.

In some examples, for crops such as raspberries, higher pore water EC outside of a certain range can reduce yield. Two zones may have the same pore water EC average (e.g., an average of four), but one zone may have a standard deviation of two EC while the other zone has a standard deviation of one EC. In a zone with a thousand plants and a higher standard deviation, approximately three or four hundred plants may be experiencing water stress at a given time as a result. In a zone with the same average but a lower standard deviation, perhaps only approximately one or two hundred plants may be experiencing water stress, because the normal distribution of plants is tighter in that zone.

In some examples, the fertigation control system can therefore be configured to trigger irrigation based on an estimated standard deviation of the pore water EC calculated from the deployed sensors, rather than or in addition to the average EC. Thus, the tolerance value 114 can comprise tolerance conditions including multiple factors, such as an average EC factor and an EC standard deviation factor, or the growing medium indicators of block 314 can include an estimated or calculated standard deviation in addition to an average pore water EC of the plants or zone. Whenever the standard deviation is outside of a certain predetermined or preferred range of values, the system can initiate watering or generate an alert for the user even if the average EC is within acceptable limits. In some examples, other measures of variability can be used instead of the standard deviation of the data, such as the range of the EC values, the variance, the mean absolute deviation (MAD), or similar measures.

In some examples, the fertigation control system can include a standard deviation maximum threshold. If the standard deviation between the sensors in a zone crosses a predetermined limit (e.g., a standard deviation of one), the system can generate an alert or take an action, such as by initiating an additional flush shot. A high standard deviation can indicate that different conditions are occurring at different plants within the zone, which may indicate that some plants in the zone are experiencing stress even if not all of them are, such as if some plants are in direct sunlight and others are more shaded. For example, if two plants have a very high EC and are experiencing stress while two other plants have a very low EC, the average of the measurements may appear acceptable, but in practice, neither group of plants may be in optimal condition.

The failure mode of a system that relies solely on averaging can occur when there are extreme values from different sensors that are not accounted for because the system is only evaluating the average. By adding a standard deviation calculation, the system can provide an additional opportunity to detect when a percentage of plants are not in optimal condition.

In some examples, the fertigation control system can leverage plant physiology to automatically adjust irrigation. Plants use water to maintain balance; when environmental conditions are hot and humidity is low, plants use more water to cool themselves and maintain leaf temperature within a range suitable for photosynthesis. When plants use water, they preferentially pull water out of the growing medium, leaving more salt behind, which raises the EC. The plant water use cycle works opposite to the irrigation cycle—irrigation replenishes water in the root zone while plants use the water for cooling and photosynthesis. The EC hitting a guardrail limit can be triggered by the plant’s water use, occurring more frequently on hot days and less frequently on cloudy days when transpiration is low.

In some examples, the fertigation control system can leverage the way plant physiology works so that on days that are very hot, the system automatically irrigates appropriately for the plant’s needs, and on days that are cloudy, the system does not waste water.

In some examples, the fertigation control system can be configured to operate according to a drainage goal. Some users may prefer to chase a drainage goal where, for every volume of water applied to the plant (e.g., 10 liters), a target volume (e.g., 2 liters) drains from the plant. This drainage-based approach may be used as an alternative or supplement to EC-based control. In some examples, when operating according to a drainage goal, the shot size can be variable. The system can be configured to select an appropriate shot size within a specified range (e.g., between 5 minutes and 20 minutes) in order to attempt to achieve the drainage goal specified by the user.

In some examples, the fertigation control system can include a "time between shots" or similar per-shot temporal spacing parameter that operates as a timer-based irrigation. A user can specify that the system irrigate at regular intervals (e.g., every 30 minutes) regardless of sensor readings. If the EC threshold is exceeded, the system can apply additional water to address the elevated EC. This combination of guardrails can maintain the plant in a condition where it is able to grow berries and biomass at a high rate without being under stress that would reduce yield.

In some examples, the fertigation control system may not include a minimum EC limit. The EC of the water applied to the plant may always be less than the EC of the growing medium, meaning the volume of water applied is proportional to the amount the EC decreases. In some examples, the system may not include a mechanism to increase EC. Generally, low EC values may not damage plants. There may be an EC value (e.g., approximately four) below which additional watering does not provide additional yield benefit. As EC increases beyond a certain threshold, yields may drop off linearly.

In some examples, the calculated standard deviation of the EC measured by the deployed sensors can be used to correlate to the true distribution of EC values across all plants in the zone. Because it may not be economically feasible to place a sensor in every pot in the zone, the standard deviation of a smaller number of sensors (e.g., four to eight sensors) can serve as a predictor of the true distribution of EC values across the zone. If a sensor were placed in every pot, the system could water when a certain percentage of plants exceeded a comfortable EC value. The standard deviation from the deployed sensors can approximate this determination to allow growers better control with reduced capital investment and system maintenance.

In some examples, the number of sensors deployed in a zone and their spatial distribution can affect the representativeness of the measurements and accuracy of the estimated properties of the zone overall. Having sensors distributed spatially in a way that provides a representative sampling technique can improve the accuracy of the system’s determinations. Accordingly, in some examples, the system can include sensors evenly distributed spatially, by plant type, by proximity to plant-affecting conditions (e.g., walls, windows, fans, water or fertigation sources, etc.), or combinations thereof to give a better representative sample of plant conditions for more accurate averages and standard deviations of the EC measurements.

In some examples, the number of sensors required for a statistically significant determination can be evaluated empirically. For a zone with a relatively large number of plants (e.g., 2,000 plants), all plants can be measured to determine the actual average for the zone. Statistical analysis can then determine how many randomly selected plants would need to be measured to determine the average within a specified accuracy percentage.

In some examples, alternative methods for detecting variability among sensors can be used. One alternative method includes calculating a delta between the minimum and maximum EC values at any particular time and using that difference as a threshold. This delta-based approach can serve as a simplified alternative to standard deviation calculations. Thus, in some examples, the system can include identifying a maximum and minimunm EC value measured in a zone, calculating a difference or delta between those values, and comparing that difference or delta to a threshold value. If the threshold value is exceeded (i.e., the difference between minimum and maximum EC is too large), the system can generate an alert and/or can initiate a fertigation or flush event to help reduce the difference or delta over time.

In some examples, sensor data from zones with low yield may show the sensors diverging and remaining divergent throughout a growing season, while sensor data from zones with high yield may show the sensors staying tightly grouped throughout the season. This correlation between sensor divergence and yield can inform the threshold values used for standard deviation-based irrigation triggering. Thus, one embodiment of the present disclosure can include monitoring one or more zones throughout a first time period (e.g., a first growing season), identifying sensor data from zones with different levels of yields, identifying standard deviations associated with the different levels of yields, and then setting a standard deviation threshold for a fertigation system during a second time period (e.g., a second growing season) that, when exceeded, causes a flush or fertigation event. The standard deviation threshold can be set by determining which zones had better yields than others during the first time period and using the standard deviations for those better-performing zones as values below the threshold while setting the standard deviations for poorer-performing zones as values above the threshold.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ± 10%, ±5%, or +2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

As used herein, conjunctive terms (e.g., "and") and disjunctive terms (e.g., "or") should be read as being interchangeable (e.g., "and/or") whenever possible. Furthermore, in claims reciting a selection from a list of elements following the phrase "at least one of," usage of "and" (e.g., "at least one of A and B") requires at least one of each of the listed elements (i.e., at least one of A and at least one of B), and usage of "or" (e.g., "at least one of A or B") requires at least one of any individual listed element (i.e., at least one of A or at least one of B). It is noted that, when described or recited herein, the use of the articles such as “a” or “an” is not considered to be limiting to only one, but instead is intended to mean one or more unless otherwise specifically noted herein.

What is claimed is:

1. A fertigation control system, comprising:
a server computer including a processor and an electronic storage device, the electronic storage device including electronic instructions to determine a pore water electrical conductivity of a growing medium in a fertigation unit; and
a sensor communicatively coupled to the server computer and configured to collect data for determining the pore water electrical conductivity of the growing medium;
wherein the processor is configured to execute the electronic instructions, including:
assimilating collected data from the sensor,
applying the collected data into a distribution algorithm,
calculating a value of the pore water electrical conductivity of the growing medium,
comparing the value with a known tolerance value and a target value, and
initiating at least one irrigation and drainage operation based on the value, the known tolerance value, and the target value.

2. The fertigation control system of claim 1, wherein the collected data from the sensor includes at least a bulk permittivity, electrical conductivity, a volumetric water content, and a temperature of the growing medium.

3. The fertigation control system of claim 1, further comprising a water control assembly in communication with the processor, the water control assembly including at least one water supply valve and at least one actuator.

4. The fertigation control system of claim 3, wherein the electronic instructions comprise instructing the processor to transmit a first control signal to activate the water control assembly to initiate irrigation and drainage operations.

5. The fertigation control system of claim 3, wherein the electronic instructions further comprise instructing the processor to transmit a second control signal to deactivate the water control assembly to terminate irrigation and drainage operations.

6. The fertigation control system of claim 1, wherein the irrigation and drainage operations comprise modifying a volume or a duration of the at least one irrigation and drainage operation based on the pore water electrical conductivity of the growing medium.

7. The fertigation control system of claim 1, wherein the sensor comprises a dielectric sensor.

8. A method of controlling watering of a plant system, the method comprising:
positioning a monitoring device in a growing medium;
collecting data from the monitoring device to determine a pore water electrical conductivity of the growing medium;
assimilating the collected data to a database of a computing device communicating with the monitoring device;
applying the collected data into a watering system algorithm; and
calculating one or more growing medium indicators to control a watering system to perform irrigation and drainage operations according to the pore water electrical conductivity of the growing medium.

9. The method of claim 8, further comprising collecting historic data corresponding to growing medium conditions and watering frequency and linking the historic data to the database of the computing device.

10. The method of claim 8, further comprising logging the collected data from the monitoring device and storing the collected data to the database of the computing device.

11. The method of claim 8, further comprising actuating a water control assembly in communication with the computing device, the water control assembly including at least one water supply valve and at least one actuator.

12. The method of claim 11, wherein the computing device is configured to activate and deactivate the water control assembly to perform irrigation and drainage operations.

13. The method of claim 8, wherein the monitoring device comprises a sensor configured to collect at least a bulk permittivity, electrical conductivity, and a temperature of the growing medium.

14. An irrigation system, comprising:
a plant system;
a watering system configured to water the plant system;
a plurality of growing medium electrical conductivity (EC) sensors configured to measure EC values in a growing medium of at least one plant area of the plant system;
a controller configured to receive data from the plurality of EC sensors, wherein the controller is configured to:
calculate a representative pore water electrical conductivity value from the plurality of EC sensors;
calculate a measure of variability of the pore water electrical conductivity from the plurality of EC sensors;
compare the representative pore water electrical conductivity value and the measure of variability with a known tolerance value and a target value; and
perform an irrigation or drainage operation based on the representative pore water electrical conductivity value, the measure of variability of the pore water electrical conductivity from the plurality of EC sensors, the known tolerance value, and the target value.

15. The irrigation system of claim 14, wherein the representative pore water electrical conductivity value is an average pore water electrical conductivity value and the measure of variability is a standard deviation of the pore water electrical conductivity from the plurality of EC sensors.

16. The irrigation system of claim 15, wherein the irrigation or drainage operation is performed if the measure of variability of the pore water electrical conductivity from the plurality of EC sensors exceeds at least one standard deviation.

17. The irrigation system of claim 14, further comprising a water control assembly communicatively coupled to the controller, the water control assembly including at least one water supply valve and at least one actuator.

18. The irrigation system of claim 17, wherein the controller is configured to instruct the watering system to transmit control signals to activate the water control assembly to initiate and terminate irrigation and drainage operations.

19. The irrigation system of claim 14, wherein the controller comprises a processor configured to perform an algorithm to assimilate the data received from the EC sensor and apply the data to calculate the representative pore water electrical conductivity value.

20. The irrigation system of claim 14, further comprising a database including historical data of conditions of the growing medium and watering events.
